(19) United States
(12) Patent Application Publication
(10) Pub. No.: US 2026/0104308 A1
(43) Pub. Date: Apr. 16, 2026

(54) WATER LEAKAGE DETECTION DEVICE AND DETECTION METHOD THEREOF

(71) Applicant: United Microelectronics Corp., Hsinchu (TW)

(72) Inventors: Chi-Chung CHEN, Tainan City (TW); Chia-Jung CHANG, Tainan City (TW)

(21) Appl. No.: 18/938,341

(22) Filed: Nov. 6, 2024

(30) Foreign Application Priority Data
Oct. 14, 2024 (TW) 113138971

(51) Int. Cl. G01M 3/16

(52) U.S. Cl. CPC G01M 3/165

(57) ABSTRACT

A water leakage detection device and a detection method thereof are provided. The water leakage detection device includes a leakage sensing tape, a processor, an infrared imaging sensor and a wireless communication transmitting module. The leakage sensing tape is used to detect whether a water leakage occurs. The processor is electrically connected to the water leakage sensing tape. The infrared imaging sensor is connected to the processor. The infrared imaging sensor is used to detect a water leakage range. The wireless communication transmitting module is connected to the processor. The wireless communication transmitting module is used to transmit a water leakage detection result.

This application claims the benefit of Taiwan application Serial No. 113138971, filed Oct. 14, 2024, the disclosure of which is incorporated by reference herein in its entirety.

### TECHNICAL FIELD

The disclosure relates in general to a detection device and a detection method thereof, and more particularly to a water leakage detection device and a detection method thereof.

### BACKGROUND

In high-tech industries, once water leakage occurs, it will directly affect the operation of the production line, the product quality and the product quantity. The traditional water leakage detection method usually only detects general water, but cannot detect pure water. In addition, the size and location of the water leakage range cannot be specifically detected. Furthermore, the detection results cannot be immediately transmitted to relevant units, and improvements cannot be made immediately.

Therefore, in order to accurately detect various water and water leakage ranges, and deliver detection results in real-time, researchers are proposing a new water leakage detection technology to improve it.

### SUMMARY

The disclosure is directed to a water leakage detection device and a detection method thereof. It uses infrared sensing, analysis, and imaging to detect the water leakage range for different kinds of water. Further, the water leakage information could be transmitted to the backend system and notified relevant personnel to handle it.

According to one embodiment, a water leakage detection device is provided. The water leakage detection device includes a leakage sensing tape, a processor, an infrared imaging sensor, and a wireless communication transmitting module. The leakage sensing tape is used to detect whether a water leakage occurs. The processor is electronically connected to the leakage sensing tape. The infrared imaging sensor is connected to the processor. The infrared imaging sensor is used to detect a water leakage range. The wireless communication transmitting module is connected to the processor. The wireless communication transmitting module is used to transmit a water leakage detection result.

According to another embodiment, a detection method of a water leakage detection device is provided. The detection method includes the following steps. Whether a water leakage occurs is detected through a leakage sensing tape. A water leakage area is detected by an infrared imaging sensor if the water leakage occurs. A water leakage detection result is transmitted, by a wireless communication transmitting module.

### BRIEF DESCRIPTION OF THE DRAWINGS

FIG. 1 illustrates a block diagram of a water leakage detection device according to an embodiment of the present disclosure.

FIG. 2 illustrates a circuit diagram of a water leakage detection device according to an embodiment of the present disclosure.

FIG. 3 illustrates a flow chart of a water leakage detection method according to an embodiment of the present disclosure.

FIG. 4 illustrates the step S100.

FIG. 5 illustrates a detailed flow chart of the step S110 according to an embodiment of the present disclosure.

FIG. 6 illustrates each step of FIG. 5.

FIG. 7 illustrates a flow chart of a switching method of the water leakage detection device for different water according to an embodiment of the present disclosure.

FIG. 8 illustrates a flow chart of the water mist detection performed by the water leakage detection device according to an embodiment of the present disclosure.

FIG. 9 illustrates a flow chart of communication channel switching by the water leakage detection device according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

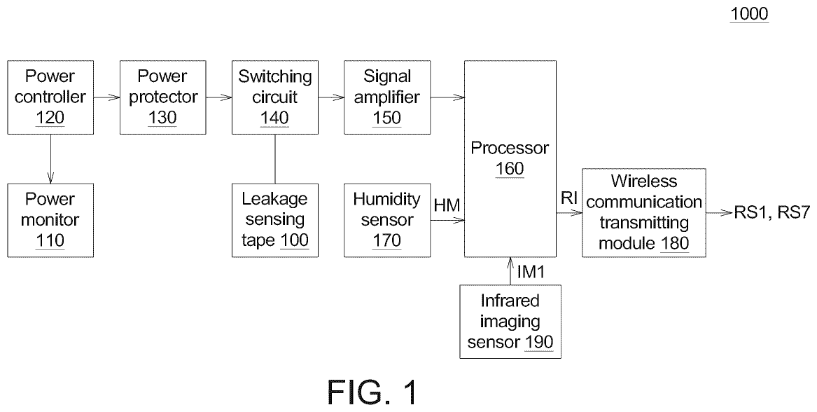

Please also refer to FIG. 1, which illustrates a block diagram of a water leakage detection device 1000 according to an embodiment of the present disclosure. The water leakage detection device 1000 includes a leakage sensing tape 100, a power monitor 110, a power controller 120, a power protector 130, a switching circuit 140, a signal amplifier 150, a processor 160, a humidity sensor 170, an infrared imaging sensor 190 and a wireless communication transmitting module 180. The leakage sensing tape 100 is used to detect whether water leakage occurs. The power monitor 110 is used to monitor the battery power output. The power controller 120 is used to turn on or turn off the power. The power protector 130 is used to prevent power surges. The switching circuit 140 is connected to the leakage sensing tape 100 and is used for switching the detection targets. The signal amplifier 150 is connected to the switching circuit 140 for signal amplification. The processor 160 is used to perform various processing procedures, analysis procedures, determining procedures, and controlling procedures. The humidity sensor 170 is used to sense the humidity. The infrared imaging sensor 190 is used for infrared detection. The wireless communication transmitting module 180 is used to transmit signals.

The power monitor 110, the power controller 120, the power protector 130, the switching circuit 140, the signal amplifier 150, the processor 160, the humidity sensor 170, the infrared imaging sensor 190 and/or the wireless communication transmitting module 180 is, for example, a circuit, a circuit board, a storage device storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

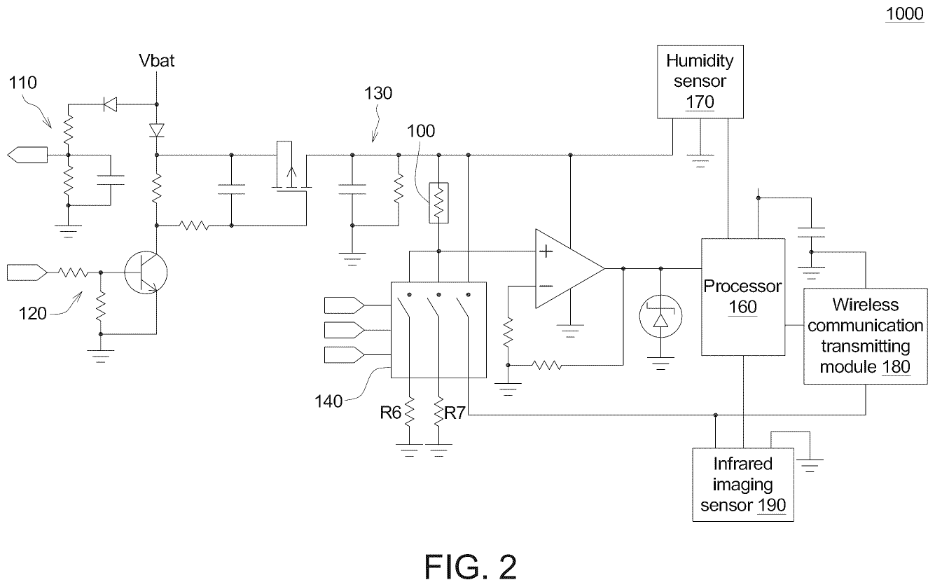

Please refer to FIG. 2, which illustrates a circuit diagram of a water leakage detection device 1000 according to an embodiment of the present disclosure. The power monitor 110 is used to monitor battery power output. As shown in FIG. 2, power Vbat is, for example, 3.6V. The power monitor 110 monitors power Vbat to ensure stable operation of the system.

The power controller 120 is used to turn on or turn off the power Vbat. As shown in FIG. 2, the power controller 120 drives the B-level of the BJT and the MOSFET PMOS as a switch for the power Vbat.

The power protector 130 is used to prevent power surges. As shown in FIG. 2, the power protector 130 controls the voltage rise rate through the charging characteristics of the capacitor of the RC ramp-up circuit to avoid the impact of instantaneous voltage changes on the circuit.

In addition, the water leakage detection device 1000 in the present disclosure could use infrared sensing, analysis and imaging to detect water leakage range, and after detecting different kinds of waters, the water leakage information could be transmitted to the background system to notify relevant personnel. The following flow chart is a detailed description of the operation of the components.

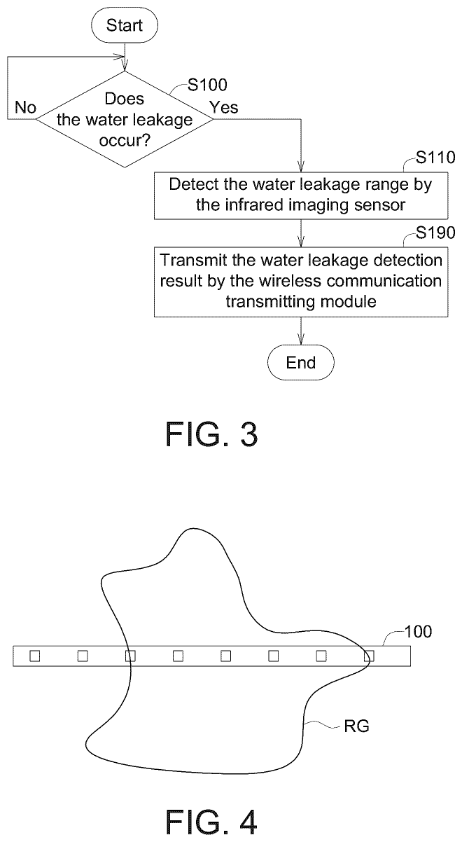

Please refer to FIG. 3, which illustrates a flow chart of a water leakage detection method according to an embodiment of the present disclosure. The water leakage detection method includes steps S100, S110, and S190.

Please refer to FIG. 4, which illustrates the step S100. In the step S100, the leakage sensing tape 100 is used to detect whether the water leakage occurs. As shown in FIG. 4, since the impedance of water is lower than that of air, when leakage sensing tape 100 encounters water, a short circuit or impedance reduction will occur. Therefore, the leakage sensing tape 100 could be used to detect whether the water leakage occurs. If the water leakage occurs, the process proceeds to the step S110.

In the step S110, as shown in the FIG. 4, a water leakage range water leakage range is detected by the infrared imaging sensor 190. When the water leakage occurs, the infrared imaging sensor 190 could be used to take pictures of the water leakage and mark the temperature and the water leakage range.

Then, in the step S190, as shown in FIG. 1, a water leakage detection result RS1 is transmitted by the wireless communication transmitting module 180. The wireless communication transmitting module 180 is, for example, a LoRa long-range wireless module. The wireless communication transmitting module 180 transmits the water leakage picture and water leakage detection result RS1 to the background management system through the LoRa technology.

LoRa long-range wireless module is a wireless modulation technology, mainly used for long-distance, low-power Internet of Things (IoT) applications. It uses spread spectrum modulation technology to transmit data in the same frequency band. It has strong anti-interference ability and long transmission distance. With the characteristics of long range and low power consumption, it is quite suitable for application in complex communication environments such as semiconductor factories.

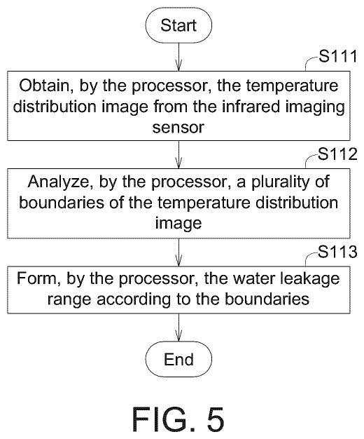

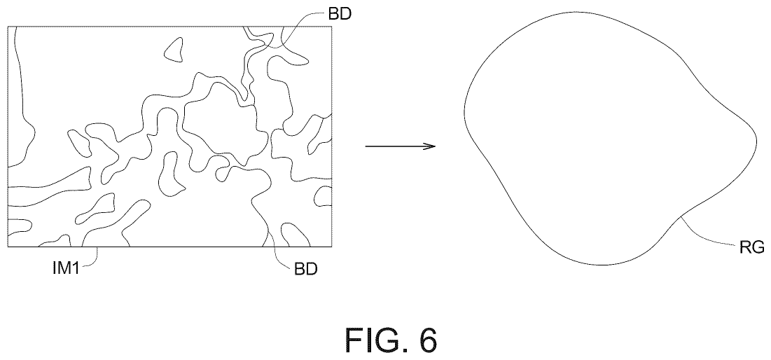

Please refer to FIGS. 5 and 6. FIG. 5 illustrates a detailed flow chart of the step S110 according to an embodiment of the present disclosure, and FIG. 6 illustrates each step of FIG. 5. The step S110 of detecting the water leakage range RG by the infrared imaging sensor 190 includes step S111 to step S113.

In the step S111, as shown in the FIG. 6, the processor 160 obtains a temperature distribution image IM1 from the infrared imaging sensor 190. In the analysis of the infrared imaging sensing value of the infrared imaging sensor 190, the resolution of the original data obtained by the infrared imaging sensor 190 is upgraded, for example, using a Gaussian interpolation algorithm. The method sequence is as follows:
(1) Initialization is carried out, and the original image matrix of W×H is enlarged to 2W×2H.

$$Kernel is selected as \frac{1}{16} [ \begin{matrix}1 & 2 & 1 \\ 2 & 4 & 2 \\ 1 & 2 & 1\end{matrix} ] . \qquad ( 2 )$$

(3) Sub-pixel segmentation is performed to divide each of the pixels into four sub-pixels. The positions of these sub-pixels could be expressed as (i, j), (i+0.5, j), (i, j+0.5) and (i+0.5, j+0.5).
(4) Kernel factor calculation is performed, using a Gaussian kernel to interpolate each sub-pixel. The value of each of the sub-pixels is calculated according to the weight of its surrounding pixel values and the kernel factor.
(5) Interpolation calculation is performed, and for each pixel, its four sub-pixels are calculated.

In order to confirm the water leakage range RG, the processor 160 could, for example, use the display panel to present the image captured by the infrared imaging sensor 190, and perform pseudo-color processing to convert the temperature into pseudo-color to obtain the temperature distribution image IM1.

Next, in the step S112, as shown in the FIG. 6, the processor 160 analyzes a plurality of boundaries BD of the temperature distribution image IM1. For example, the processor 160 performs the boundary algorithm on the temperature distribution to find pixels with large temperature changes. Then, these pixels with large temperature changes are connected to obtain the boundaries BD.

Then, in the step S113, as shown in the FIG. 6, the processor 160 forms the water leakage range RG according to the boundaries BD in the temperature distribution image IM1.

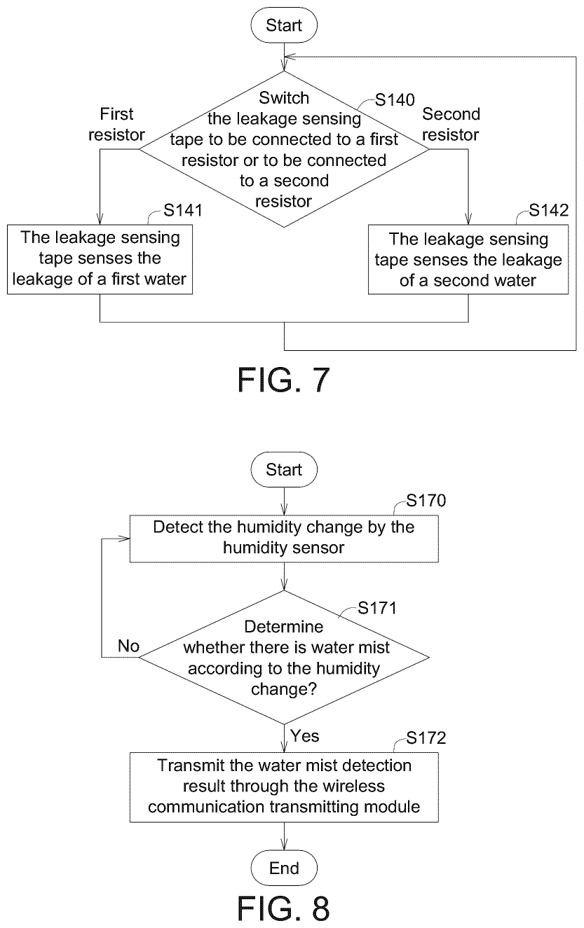

Please refer to FIG. 7, which illustrates a flow chart of a switching method of the water leakage detection device 1000 for different water according to an embodiment of the present disclosure. The water leakage detection method further includes step S140 to step S142.

In the step S140, as shown in the FIG. 2, the leakage sensing tape 100 is switched to be connected to a first resistor R6 or to be connected to a second resistor R7 by the switching circuit 140.

In the switching circuit method performed by the switching circuit 140, the switching circuit 140 is used to switch three channels through the I/O pin. The path connected to the first resistor R6 is used to measure general water; the path connected to the second resistor R7 is used to measure pure water; the path not connected to the first resistor R6 and the second resistor R7 is used to turn off the supply power of peripheral components.

Since general water contains impurities such as minerals, metals or ions, the impedance of general water is low; pure water has no minerals or ions, so its impedance is higher. The first resistor R6 and the second resistor R7 with different resistance values could be used to measure the general water and the pure water with different impedances. If the switching circuit 140 switches the leakage sensing tape 100 to be connected to the first resistor R6, then the process proceeds to the step S141; if the switching circuit 140 switches the leakage sensing tape 100 to be connected to the second resistor R7, then the process proceeds to the step S142.

In the step S141, as shown in the FIG. 2, the leakage sensing tape 100 is used to sense the leakage of a first water, such as the general water.

In the step S142, as shown in the FIG. 2, the leakage sensing tape 100 is used to sense the leakage of a second water, such as the pure water. The impedance of the first water is different from the impedance of the second water.

The divided voltage signal between the leakage sensing tape 100 and the first resistor R6 (or the second resistor R7) is amplified by the signal amplifier 150 and then is inputted to the processor 160 for filtering processing.

Please refer to FIG. 8, which illustrates a flow chart of the water mist detection performed by the water leakage detection device 1000 according to an embodiment of the present disclosure. The water leakage detection method further includes step S170 to step S172.

In the step S170, as shown in the FIG. 1, a humidity change HM is detected by the humidity sensor 170. The principle of the humidity sensor 170 to measure the humidity change HM is measure the change of the sensor capacitance value. This type of sensor consists of two parallel electrodes and a dielectric material.

Then, in the step S171, as shown in the FIG. 1, the processor 160 determines whether there is water mist according to the humidity change. If the water mist exists, the process proceeds to the step S172.

Then, in the step S172, as shown in FIG. 1, a water mist detection result RS7 is transmitted through the wireless communication transmitting module 180.

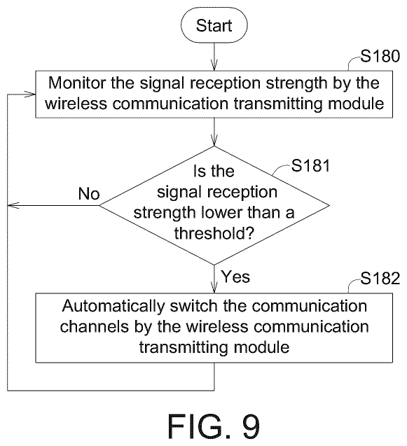

Please refer to FIG. 9, which illustrates a flow chart of communication channel switching by the water leakage detection device 1000 according to an embodiment of the present disclosure. The water leakage detection method further includes step S180 to step S182. In the step S180, a signal reception strength RI is monitored by the wireless communication transmitting module 180. The transceiver of the wireless communication transmitting module 180 has a built-in RSSI detection function, which can monitor the strength of the received signal in real-time.

Next, in the step S181, the wireless communication transmitting module 180 determines whether the signal reception strength RI is lower than a threshold. If the signal reception strength RI is lower than the threshold, the process proceeds to the step S182; if the signal reception strength RI is not lower than the threshold, the process proceeds to the step S180.

Then, in the step S182, the wireless communication transmitting module 180 automatically switches communication channels, for example, between 433 MHz and 923 MHz frequency bands to find a channel with better signals for communication.

According to the above various implementations of the water leakage detection 100 and the water leakage detection method, the water leakage or the water mist could be detected in real-time, and the water leakage range RG could be directly obtained through the infrared imaging sensor 190. Moreover, the wireless communication transmitting module 180 could automatically switch communication channels to avoid interference signals, and the data would be successfully transmitted without the frequency interference. It could instantly transmit the water leakage detection result to the background system to avoid disasters.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A water leakage detection device, comprising:
a leakage sensing tape, used to detect whether a water leakage occurs;
a processor, electronically connected to the leakage sensing tape;
an infrared imaging sensor, connected to the processor, wherein the infrared imaging sensor is used to detect a water leakage range; and
a wireless communication transmitting module, connected to the processor, wherein the wireless communication transmitting module is used to transmit a water leakage detection result.

2. The water leakage detection device according to claim 1, wherein the processor is used to obtain a temperature distribution image from the infrared imaging sensor, analyze a plurality of boundaries in the temperature distribution image, and then form the water leakage range according to the boundaries.

3. The water leakage detection device according to claim 1, wherein the processor performs pseudo-color processing to convert temperature into pseudo-color to obtain the temperature distribution image.

4. The water leakage detection device according to claim 1, further comprising:
a switching circuit, used to switch the leakage sensing tape to be connected to a first resistor to sense a first water, or switch the leakage sensing tape to be connected to a second resistor to sense a second water.

5. The water leakage detection device according to claim 4, wherein an impedance of the first water is different from an impedance of the second water.

6. The water leakage detection device according to claim 1, further comprising:
a humidity sensor, connected to the processor, wherein the humidity sensor is used to detect a humidity change.

7. The water leakage detection device according to claim 6, wherein the processor determines whether there is a water mist according to the humidity change.

8. The water leakage detection device according to claim 7, wherein the wireless communication transmitting module is further used to transmit a water mist detection result.

9. The water leakage detection device according to claim 1, wherein the wireless communication transmitting module is a LoRa long-distance wireless module.

10. The water leakage detection device according to claim 1, wherein the wireless communication transmitting module monitors a signal reception strength, and when the signal reception strength is lower than a threshold, the wireless communication transmitting module automatically switches communication channels.

11. A detection method of a water leakage detection device, comprising:
detecting whether a water leakage occurs through a leakage sensing tape;
detecting, by an infrared imaging sensor, a water leakage range if the water leakage occurs; and
transmitting, by a wireless communication transmitting module, a water leakage detection result.

12. The detection method of the water leakage detection device according to claim 11, wherein the step of detecting, by the infrared imaging sensor, the water leakage area includes:
obtaining, by a processor, a temperature distribution image from the infrared imaging sensor;
analyzing, by the processor, a plurality of boundaries in the temperature distribution image; and
forming, by the processor, the water leakage range according to the boundaries.

13. The detection method of the water leakage detection device according to claim 11, wherein the processor performs pseudo-color processing to convert temperature into pseudo-color to obtain the temperature distribution image.

14. The detection method of the water leakage detection device according to claim 11, further comprising:
switching, by a switching circuit, the leakage sensing tape to be connected to a first resistor to sense a first water, or switching, by the switching circuit, the leakage sensing tape to be connected to a second resistor to sense a second water;
sensing, through the leakage sensing tape, the leakage of a first water if the leakage sensing tape is connected to the first resistor; and
sensing, through the leakage sensing tape, the leakage of a second water if the leakage sensing tape is connected to the second resistor.

15. The detection method of the water leakage detection device according to claim 14, wherein an impedance of the first water is different from an impedance of the second water.

16. The detection method of the water leakage detection device according to claim 11, further comprising:
detecting, by a humidity sensor, a humidity change.

17. The detection method of the water leakage detection device according to claim 16, further comprising:
determining, by the processor, whether there is a water mist according to the humidity change.

18. The detection method of the water leakage detection device according to claim 17, further comprising:
transmitting, by the wireless communication transmitting module, a water mist detection result if there is the water mist.

19. The detection method of the water leakage detection device according to claim 11, wherein the wireless communication transmitting module is a LoRa long-distance wireless module.

20. The detection method of the water leakage detection device according to claim 17, further comprising:
monitoring, by the wireless communication transmitting module, a signal reception strength;
determining, by the wireless communication transmitting module, whether the signal reception strength is lower than a threshold; and
automatically switching, by the wireless communication transmitting module, communication channels if the signal reception strength is lower than the threshold.
